(19) United States
(12) Patent Application Publication
(10) Pub. No.: US 2012/0218197 A1
(43) Pub. Date: Aug. 30, 2012

(54) ELECTRONIC DEVICE AND METHOD FOR STARTING APPLICATIONS IN THE ELECTRONIC DEVICE

(75) Inventor: CHIA-YUAN CHANG, Tu-Cheng (TW)

(73) Assignee: CHI MEI COMMUNICATION SYSTEMS, INC., Tu-Cheng (TW)

(21) Appl. No.: 13/310,712

(22) Filed: Dec. 3, 2011

(30) Foreign Application Priority Data
Feb. 24, 2011 (TW) 100106120

(51) Int. Cl. G06F 3/041

(52) U.S. Cl. 345/173

(57) ABSTRACT

An electronic device includes a touch screen, a storage device, and a processor. The storage device stores a graphic database that includes a plurality of standard graphics. The touch screen detects a touch signal consisting of one or more touches, and determines the coordinates of the one or more touches. The processor generates a graphic according to the coordinates, searches for a standard stored graphic that matches the generated graphic in the storage device, and starts the application in the electronic device that is associated with the searched standard graphic.

### BACKGROUND

1. Technical Field

The embodiments of the present disclosure relate to application software management systems and methods, and particularly to an electronic device and a method for starting applications in the electronic device.

2. Description of Related Art

Electronic devices, such as mobile phones, provide multiple applications that may be used by users. For example, a mobile phone may include applications such as a calendar, a phonebook, an album, a short messaging service, a music player, a search engine, and so on. Applications may be started in the device by searching for a desired application by viewing a list of icons in a function menu, or by setting a hotkey for each favorite application, and pressing a hotkey to start the desired application. The former method is not time-efficient, the latter method is easier. However, if too many hotkeys are set, it is difficult to remember the associations between the hotkeys and applications.

### BRIEF DESCRIPTION OF THE DRAWINGS

FIG. 1 is a block diagram of one embodiment of function modules of an electronic device comprising an application starting system.

FIG. 2 is a flowchart of one embodiment of a method for starting applications in the electronic device of FIG. 1.

FIG. 3 illustrates graphics in a graphic database for exemplary.

FIG. 4 illustrates drawing of a graphic in a graphic-sensitive area on a touch screen of the electronic device in FIG. 1 for exemplary.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

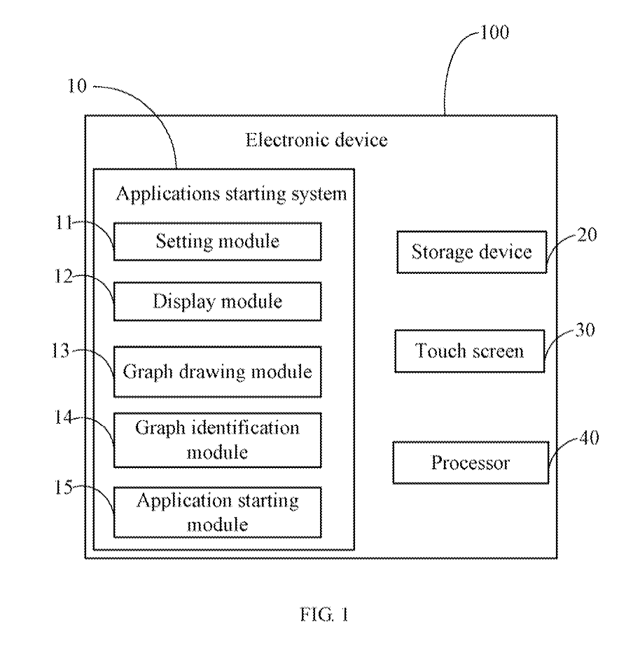

FIG. 1 is a block diagram of one embodiment of function modules of an electronic device 100. In one embodiment, the electronic device 100 includes an application starting system 10, a storage device 20, a touch screen 30, and a processor 40. Depending on the embodiment, the electronic device may be a portable computer, a personal digital assistant, or a smart mobile phone or the like. The application starting system 10 receives and analyzes a signal or series of signals following a trace of a stylus or a fingertip on the touch screen 30 (touch signal), reconstitutes the shape or symbol or letter in the graphic data in relation to the touch signal, searches for a standard graphic that matches the generated graphic data in the storage device 20, and starts an application in the electronic device that is associated with the searched standard graph.

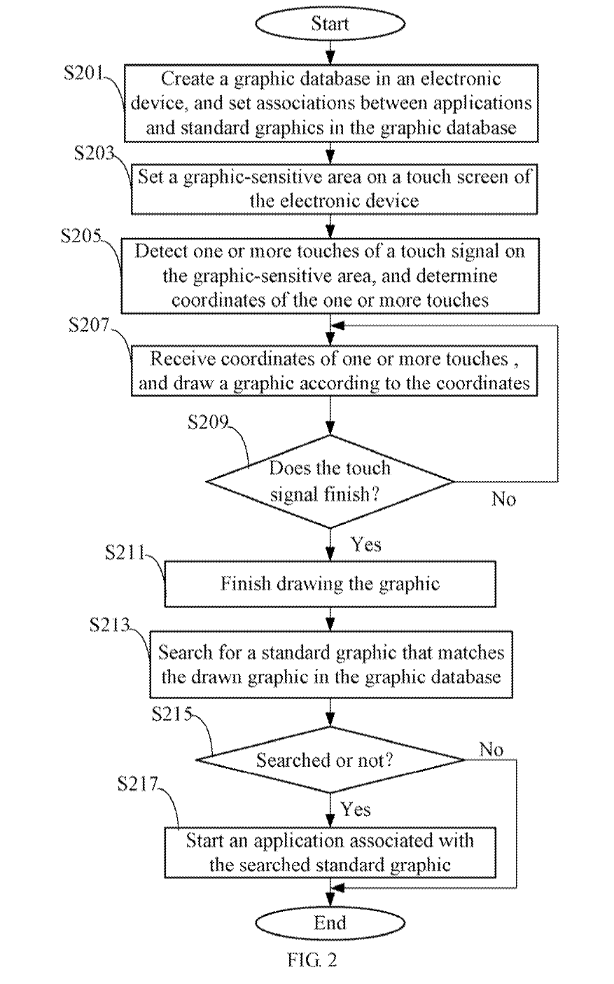

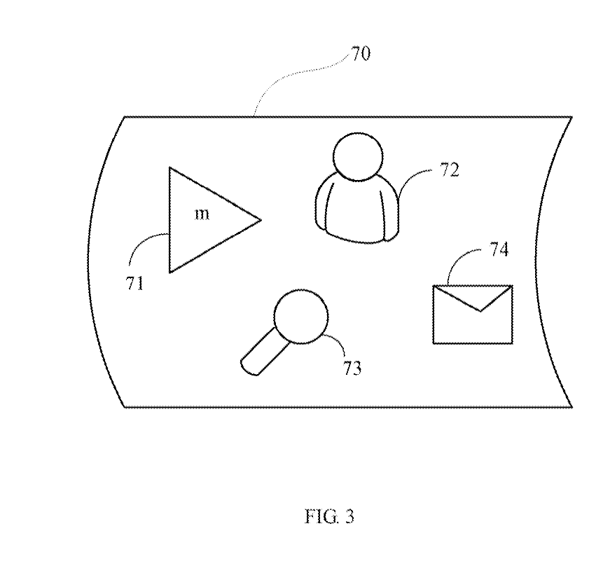

As shown in FIG. 1, the application starting system 10 includes a setting module 11, a display module 12, a graphic drawing module 13, a graphic identification module 14, and an application starting module 15. The modules 11-15 may include computerized code in the form of one or more programs that are stored in the storage device 20. The computerized code includes instructions to be executed by the processor 40 to provide functions of the modules 11-15 as illustrated in FIG. 2.

In one embodiment, the storage device 20 further stores computerized code or data in relation to applications installed in the electronic device 100. For example, the applications may include a calendar, a phonebook, an album, a short messaging service, a music player, a search engine, or a web browser. The storage device 20 may be a cache or a dedicated memory, such as an EPROM, HDD, or flash memory.

The touch screen 30 detects position data of the touch signal on the display screen 30, and sends the position data to the application starting system 10 for analyzing and processing. Depending on the embodiment, the touch screen 30 may include the capacitive, resistive, infrared, surface acoustic wave, and electromagnetic types, for example. The mechanisms for recognizing the position data of the touch event are known to technology and may be different due to different types of the touch screen 30.

FIG. 2 is a flowchart of one embodiment of a method for starting applications in the electronic device 100. Depending on the embodiment, additional blocks may be added, others removed, and the ordering of the blocks may be changed.

In block S201, the setting module 11 creates a graphic database 70 in the electronic device 100. In one embodiment, the graphic database 70 stores a plurality of standard graphics. Each standard graphic may be a simple shape, a number, a letter, a character or a symbol, or any drawing which the user finds easy to remember. For example, as shown in FIG. 3, graphics 71-74 are standard graphics in the graphic database 70, the graphic 71 is a combination of a triangle and the character “m”, the graphic 72 is the outline of a person, the graphic 73 is the shape of a magnifying glass, and the graphic 74 is the shape of an envelope. The setting module 11 further set associations between the graphics in the graphic database 70 and the applications. For example, the graphic 71 may be associated with the music player, the graphic 72 may be associated with the phonebook, the graphic 73 may be associated with the search engine, and the graphic 74 may be associated with the short message service.

In one embodiment, the graphic database 70 may be created by a manufacturer of the electronic device 100, or by a user (such as a buyer) of the electronic device 100. The standard graphics in the graphic database 70 can be added, deleted, or amended as the user requires. The associations can also be made, deleted, or remade.

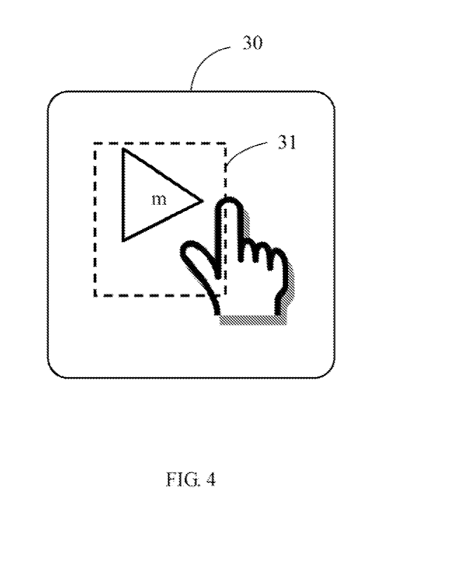

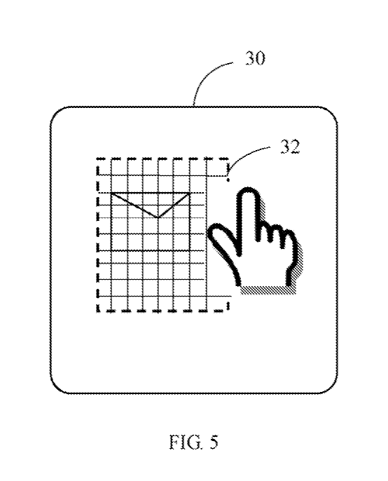

In block S203, the setting module 11 sets an area on the touch screen 30 which is sensitive to touch signals (graphic-sensitive area). A touch signal detected on the graphic-sensitive area will enable the functions of the application start system 10 as described in paragraph [0009]. The graphic-sensitive area is invisible until touched, and becomes visible when a touch signal is detected on the graphic-sensitive area. In one embodiment, the graphic-sensitive area may be a blank area (such as the area 31 shown in FIG. 4), or an area consisting of grids (such as the area 32 shown in FIG. 5) where the grid(s) facilitates the drawing of better shapes.

In block S205, the touch screen 30 detects one or more touches of a touch signal on the graphic-sensitive area. The touch screen 30 further determines coordinates of the one or more touches, and in sequence sends the coordinates to the graphic drawing module 13. The input device may be a human finger and/or a stylus, for example. When any touch is detected on the graphic-sensitive area, the display module 12 enables the whole graphic-sensitive area to be visible (as shown in FIG. 4 and FIG. 5).

In block S207, the graphic drawing module 13 receives the coordinates of the one or more touches on the graphic-sensitive area, and draws a graphic on the graphic-sensitive area according to the coordinates of the one or more touches.

In block S209, the graphic drawing module 13 determines if the touch signal has been finished by determining the absence of further coordinates within a preset time. If the touch signal has not finished, the procedure returns to block S207, the graphic drawing module 13 awaits further received coordinates sent by the touch screen 30 until the expiry of the preset time. If the touch signal finishes, for example, if the graphic drawing module 13 does not receive further coordinates sent by the touch screen 30 within five seconds, the procedure goes to block S211.

In block S211, the graphic drawing module 13 finishes drawing the graphic. As shown in FIG. 4, the drawn graphic is an icon associated with the media player, and in FIG. 5, the drawn graphic is a shape of an envelope that associated with the short message service.

In block S213, the graphic identification module 14 searches in the graphic database 70 for a standard graphic that matches the drawn graphic by comparing the drawn graphic with the stored standard graphics one by one.

In block S215, the graphic identification module 14 determines if the standard graphic that matches the drawn graphic has been found in the graphic database 70. If the graphic identification module 14 fails to find the standard graphic that matches the drawn graphic, the procedure ends. Otherwise, if the standard graphic that matches the drawn graphic has been found, for example, if a similarity between the drawn graphic and a standard graphic satisfies a preset proportion (e.g., 80%), the procedure goes to block 5217.

In block S217, the application starting module 15 automatically starts an application associated with the searched standard graph. For example, if the graphic 71 is determined to be the matching graphic, the media player is started, or if the graphic 74 is determined to be the matching graph, the short message service is started.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being performed by execution of instructions by a processor of an electronic device for starting applications in the electronic device, the method comprising:
creating a graphic database comprising a plurality of standard graphs, and setting associations between the applications and the standard graphs;
setting a graphic-sensitive area on a touch screen of the electronic device;
detecting one or more touches of a touch signal on the graphic-sensitive area, and determining coordinates of the one or more touches by the touch screen;
drawing a graphic according to the coordinates of the one or more touches;
finishing drawing the graphic on condition that no further coordinates are detected within a preset time;
searching for a standard graphic that matches the drawn graphic in the graphic database by comparing the drawn graphic with the standard graphics; and
automatically starting an application associated with the searched standard graphic.

2. The method of claim 1, wherein the graphic-sensitive area is invisible on the touch screen if no touch signal is detected on the graphic-sensitive area, and becomes visible on the touch screen if any touch signal is detected on the graphic-sensitive area.

3. The method of claim 2, wherein the graphic-sensitive area is a blank area on the touch screen or an area consisting of grids on the touch screen.

4. The method of claim 1, wherein the standard graphic is determined to match the drawn graphic on condition that a similarity between the drawn graphic and the standard graphic satisfies a preset proportion.

5. The method of claim 1, wherein each standard graphic is a simple shape, a number, a letter, a character or a symbol, or any drawing which a user finds easy to remember.

6. A non-transitory medium storing a set of instructions, the set of instructions capable of being executed by a processor of an electronic device to perform a method for starting applications in the electronic device, the method comprising:
creating a graphic database comprising a plurality of standard graphics, and setting associations between the applications and the standard graphics;
setting a graphic-sensitive area on a touch screen of the electronic device;
detecting one or more touches of a touch signal on the graphic-sensitive area, and determining coordinates of the one or more touches by the touch screen;
drawing a graphic according to the coordinates of the one or more touches;
finishing drawing the graphic on condition that no further coordinates are detected within a preset time;
searching for a standard graphic that matches the drawn graphic in the graphic database by comparing the drawn graphic with the standard graphics; and
automatically starting an application associated with the searched standard graph.

7. The medium of claim 6, wherein the graphic-sensitive area is invisible on the touch screen if no touch event is detected on the graphic-sensitive area, and becomes visible on the touch screen if the touch event is detected on the graphic-sensitive area.

8. The medium of claim 7, wherein the graphic-sensitive area is a blank area on the touch screen or an area consisting of grids on the touch screen.

9. The medium of claim 6, wherein the standard graphic is determined to match the drawn graphic on condition that a similarity between the drawn graphic and the standard graphic satisfies a preset proportion.

10. The medium of claim 6, wherein each standard graphic is a simple shape, a number, a letter, a character or a symbol, or any drawing which a user finds easy to remember.

11. An electronic device, comprising:
a storage device;
a touch screen;
a processor; and
one or more programs stored in the storage device and being executable by the processor, the one or more programs comprising instructions:
to create a graphic database comprising a plurality of standard graphics, and set associations between the applications and the standard graphics;
to set a graphic-sensitive area on a touch screen of the electronic device;
to receives coordinates of one or more touches of a touch signal detected by the touch screen;
to draw a graphic according to the coordinates of the one or more touches;
to finish drawing the graphic on condition that no further coordinates are received from the touch screen within a preset time;
to search for a standard graphic that matches the drawn graphic in the graphic database by comparing the drawn graphic with the standard graphics one by one; and
to automatically start an application associated with the searched standard graph.

12. The device of claim 11, wherein the graphic-sensitive area is invisible on the touch screen if no touch event is detected on the graphic-sensitive area, and becomes visible on the touch screen if any touch event is detected on the graphic-sensitive area.

13. The device of claim 12, wherein the graphic-sensitive area is a blank area on the touch screen or an area consisting of grids on the touch screen.

14. The device of claim 11, wherein the standard graphic is determined to match the drawn graphic on condition that a similarity between the drawn graphic and the standard graphic satisfies a preset proportion.

15. The device of claim 11, wherein each standard graphic is a simple shape, a number, a letter, a character or a symbol, or any drawing which a user finds easy to remember.
